(19) United States
(12) Patent Application Publication
(10) Pub. No.: US 2023/0283354 A1
(43) Pub. Date: Sep. 7, 2023

(54) COMMUNICATION DEVICE THAT COMMUNICATES BY FORMING A BEAM AND COMMUNICATION METHOD THEREOF, AND COMPUTER-READABLE STORAGE MEDIUM

(71) Applicant: KDDI CORPORATION, Tokyo (JP)

(72) Inventors: Masaya SHIBAYAMA, Tokyo (JP); Kazuya MORIWAKI, Tokyo (JP); Masahito UMEHARA, Tokyo (JP)

(21) Appl. No.: 18/197,284

(22) Filed: May 15, 2023

Related U.S. Application Data
(63) Continuation of application No. PCT/JP21/40459, filed on Nov. 2, 2021.

(30) Foreign Application Priority Data
Nov. 18, 2020 (JP) 2020-191874
Dec. 2, 2020 (JP) 2020-200456
Dec. 2, 2020 (JP) 2020-200457

(51) Int. Cl. H04B 7/06

(52) U.S. Cl. CPC H04B 7/06966

(57) ABSTRACT

A communication device communicates with the partner device by forming a first beam used when transmitting a signal to the partner device based on a state of the transmission path estimated by the communication device, or by forming a second beam used when transmitting a signal to the partner device based on information pertaining to specification of a beam used when transmitting a signal to the partner device determined by the partner device, and controls, during communication with the partner device using the first beam, to switch a beam to be used from the first beam to the second beam based on a first wireless quality in the partner device for a first wireless signal transmitted using the first beam and a second wireless quality in the partner device for a second wireless signal transmitted using a predetermined beam related to the second beam.

### CROSS-REFERENCE TO RELATED APPLICATION(S)

This application is a continuation of International Patent Application No. PCT/JP2021/040459 filed on Nov. 2, 2021, which claims priority to and the benefit of Japanese Patent Application Nos. 2020-191874 filed on Nov. 18, 2020, 2020-200456 filed on Dec. 2, 2020, and 2020-200457 filed on Dec. 2, 2020, the entire disclosures of which are incorporated herein by reference.

### BACKGROUND OF THE INVENTION

### Field of the Invention

The present invention relates to a control technique for a communication device that uses a plurality of antennas to form a beam.

### Description of the Related Art

In the technical field of wireless communication, there are known technologies that use a plurality of antennas to form a beam and effectively utilize spatial resources in order to improve throughput and increase communication capacity. These techniques include, for example, Multiple-Input Multiple-Output (MIMO) and antenna diversity.

To use spatial resources even more effectively, it is necessary to achieve further advancements in communication using beams.

### SUMMARY OF THE INVENTION

The present disclosure provides an advanced technique for communication using beams.

According to one aspect of the present invention, there is provided a communication device comprising: one or more processors; and one or more memories that store a computer-readable instruction for causing, when executed by the one or more processors, the one or more processors to function as: an estimation unit configured to estimate a state of a transmission path between the communication device and a partner device, using a wireless signal transmitted from the partner device; an obtaining unit configured to obtain information pertaining to specification of a beam used when the communication device transmits a signal to the partner device, determined by the partner device based on the wireless signal transmitted by the communication device; a communication unit configured to communicate with the partner device by forming a first beam used when transmitting a signal to the partner device based on the state of the transmission path estimated, or by forming a second beam used when transmitting a signal to the partner device based on the information obtained; and a control unit configured to control, during communication with the partner device using the first beam, the communication unit to switch a beam to be used from the first beam to the second beam based on a first wireless quality in the partner device for a first wireless signal transmitted using the first beam and a second wireless quality in the partner device for a second wireless signal transmitted using a predetermined beam related to the second beam.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating an example of the configuration of a wireless communication system.

FIG. 2 is a diagram illustrating an example of the hardware configuration of a device.

FIG. 3 is a diagram illustrating an example of the functional configuration of a base station device according to a first embodiment.

FIG. 4 is a diagram illustrating an example of the flow of processing executed by the base station device according to the first embodiment.

FIG. 5 is a diagram illustrating an example of the functional configuration of a base station device according to a second embodiment.

FIG. 6 is a diagram illustrating an example of the functional configuration of a terminal device according to the second embodiment.

FIG. 7 is a diagram illustrating an example of the flow of processing according to the second embodiment.

FIG. 8 is a diagram illustrating an example of the functional configuration of a base station device according to a third embodiment.

FIG. 9 is a diagram illustrating an example of the functional configuration of a terminal device according to the third embodiment.

FIG. 10 is a diagram illustrating an example of the flow of processing executed by the base station device according to the third embodiment.

FIG. 11 is a diagram illustrating an example of the flow of processing executed by the terminal device according to the third embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

System Configuration

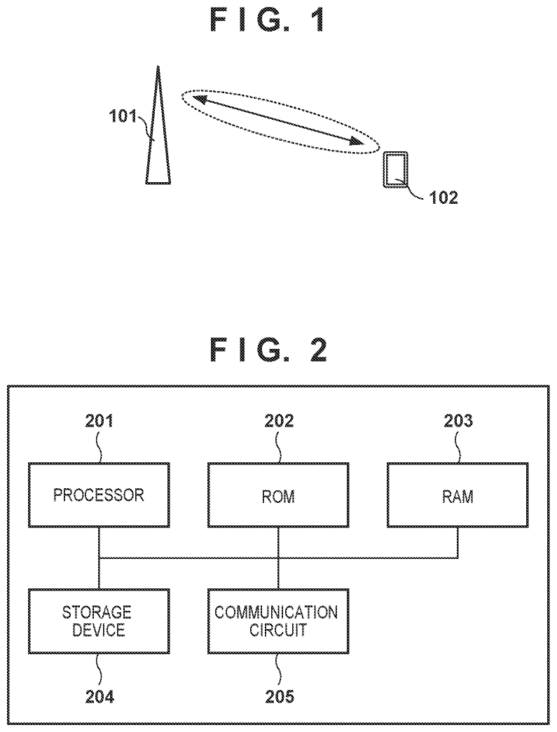

FIG. 1 illustrates an example of the configuration of a wireless communication system according to the present embodiment. The wireless communication system is, for example, a Long Term Evolution (LTE) or Fifth Generation (5G) cellular communication system, and includes a base station device 101 having at least one antenna and a terminal device 102 having at least one antenna. The base station device 101 and the terminal device 102 are examples of communication devices, and at least one thereof is assumed to use a plurality of antennas to form a beam and perform communication. In other words, this communication system can be said to be any wireless communication system in which a communication device having a plurality of antennas uses the plurality of antennas to transmit a wireless signal (wireless frames) to a partner device having at least one antenna by forming a beam based on an estimated value for the state of a transmission path with the partner device. For example, if the base station device 101 has a plurality of antennas, the base station device 101 uses the plurality of antennas to form a beam and perform wireless communication with the terminal device 102, which has at least one antenna. Additionally, for example, if the terminal device 102 has a plurality of antennas, the terminal device 102 uses the plurality of antennas to form a beam and perform wireless communication with the base station device 101, which has at least one antenna. The device on the receiving end of the wireless signal can also use the plurality of antennas to form a beam to improve the gain and the like when receiving that wireless signal.

Throughout the present embodiment and the appended claims, the “state” of the transmission path between the communication device and the partner device refers to the state of the transmission path between each of the at least one antenna of the communication device and each of the at least one antenna of the partner device. For example, if the base station device 101 has N antennas and the terminal device 102 has M antennas, the states of N×M transmission paths are estimated. The base station device 101, for example, calculates weights to be multiplied with the wireless frames to be transmitted at each of the plurality of antennas based on the estimated values of the transmission path states, and transmits the wireless frames to be transmitted, which have been multiplied by the weights, from the plurality of antennas in parallel. Note that if the terminal device 102 has a plurality of antennas, for example, the base station device 101 can transmit a plurality of data streams to the terminal device 102 in parallel. In other words, it is possible to use a Multiple-Input Multiple-Output (MIMO) technique between the base station device 101 and the terminal device 102, where both devices use a plurality of antennas to transmit and receive a plurality of streams. In this approach, the plurality of data streams can be spatially multiplexed and transmitted in the same frequency band at the same time. In this case, for example, the vector of the data stream to be transmitted by each transmitting antenna is generated by multiplying a vector representing each data stream with an antenna weight matrix (precoding matrix) of the number of transmitting antennas x the number of receiving antennas. Each of the plurality of antennas of the base station device 101 (the transmitting side) then transmits the corresponding element among those vectors. Through this, in one example, it is possible to extract a plurality of transmitted streams at high quality from signals received by each antenna of the terminal device 102 (the receiving side).

Hereinafter, several embodiments will be described on the premise of a wireless communication system that communicates by forming a beam in this manner.

### First Embodiment

In the cellular communication system, the base station device 101 can estimate the state of the transmission path based on uplink signals transmitted from the terminal device 102 (e.g., SRS (Sounding Reference Signal) and DMRS (Demodulation Reference Signal)). The base station device 101 can then adjust the antenna weights based on the estimated values, form a beam having a narrow shape and sufficiently high gain in an orientation direction, and communicate with the terminal device 102. With this approach, as described above, a beam which has a gain in the orientation direction that is sufficiently high and which is therefore suited to the terminal device 102 can be generated, and thus the base station device 101 can transmit data to the terminal device 102 at a high throughput. Although this approach can also be used in frequency-division duplex (FDD) systems, it is particularly useful in time-division duplex (TDD) systems.

Additionally, in the cellular communication system, the terminal device 102 can observe a CSI-RS (Channel State Information Reference Signal) transmitted from the base station device 101 and estimate the state of the downlink transmission path based on that CSI-RS. Based on a result of the estimation, the terminal device 102 specifies one of a plurality of PMI (Precoding Matrix Indicator) values corresponding to respective ones of a plurality of antenna weight patterns prepared in advance, and notifies the base station device 101 of the specified PMI value. The base station device 101 can form a beam using the antenna weights corresponding to the PMI for which the notification was made, and communicate with the terminal device 102. The technique using the PMI makes it possible to set the beam with less feedback by having the terminal device 102 estimate the transmission path, select a roughly suitable beam based on the estimated value for that transmission path, and feed back only the result of that selection.

A first beam formed by the base station device 101 based on the estimation of the state of the transmission path is the beam best suited to the state of the transmission path at the time the terminal device 102 transmits the wireless signal. However, this first beam has a narrow beam width and is vulnerable to changes in the state of the transmission path, such as when the terminal device 102 moves, and the throughput can degrade sharply in the event of such a change. On the other hand, a second beam, which is obtained by the terminal device 102 determining the precoding matrix to be used from among precoding matrix candidates, is the most suitable of the candidates at the time of that determination, but has insufficient performance compared to the first beam in most cases. In other words, the approach using the PMI provides only a limited number of precoding matrix candidates to reduce the amount of feedback, and thus the second beam is roughly suitable, but not optimal, for the state of the transmission path in terminal device 102. Accordingly, the second beam is generally inferior to the first beam in terms of quality, such as throughput. On the other hand, the second beam is set to be roughly suited to the state of the transmission path and therefore tends to provide sufficient gain even if the state of the transmission path in the terminal device 102 changes, as long as the change is not large.

The present embodiment provides a technique to switch among beams appropriately based on the characteristics of the beams. Although the following will describe the base station device 101 that can communicate with the terminal device 102 while switching between the first beam and the second beam, this is merely an example, and for example, the terminal device 102 may execute similar processing, or similar processing may be executed in another wireless communication system.

In the present embodiment, a first wireless signal such as a DMRS (Demodulation Reference Signal) or a CSI-RS (Channel State Information Reference Signal) is transmitted using the first beam while the base station device 101 forms that first beam and communicates with the terminal device 102. The base station device 101 can also transmit a second wireless signal, such as a CSI-RS, using a predetermined beam (having a relatively wide beam width), for the terminal device 102 to determine the PMI, for example. The terminal device 102 then receives the first wireless signal transmitted by the first beam and measures a first wireless quality pertaining to the first wireless signal. The terminal device 102 also receives the second wireless signal transmitted by the predetermined beam and measures a second wireless quality pertaining to the second wireless signal. The wireless quality can be, for example, a signal-to-interference and noise ratio (SINR), but may also be a signal-to-noise ratio (SNR) and a received signal strength, for example. The base station device 101 then determines, based on the first wireless quality and the second wireless quality, whether to switch the beam to be used from the first beam based on SRS to the second beam based on PMI. If the base station device 101 determines to make the switch, the second beam is used instead of the first beam, and if the base station device 101 determines not to switch, the first beam continues to be used to transmit data to the terminal device 102.

In one example, the base station device 101 can determine to switch the beam to be used from the first beam to the second beam based on the difference between the first wireless quality and the second wireless quality being no greater than a predetermined level. For example, the determination to switch the beam to be used from the first beam to the second beam can be made based on the first wireless quality falling below the second wireless quality. The first beam generally has a narrow beam width, and it is assumed that the gain obtained in transmitting signals to the terminal device 102 will degrade sharply when the state of the transmission path changes due to the terminal device 102 moving or the like. Accordingly, control can be executed such that the beam to be used is switched to the second beam when the level difference between the first wireless quality and the second wireless quality approaches a level where there are signs that the first wireless quality is degraded. That is, the beam to be used may be switched from the first beam to the second beam when the first wireless quality is higher than the second wireless quality. The beam to be used may be switched from the first beam to the second beam after a value obtained by subtracting the level of the second wireless quality from the level of the first wireless quality falls below a predetermined negative value.

Note that the terminal device 102 may transmit a report pertaining to the first wireless quality and a report pertaining to the second wireless quality to the base station device 101. The base station device 101 can then make a determination to switch to the second beam as described above based on the reported values. The terminal device 102 may also report information generated based on the first wireless quality and the second wireless quality to the base station device 101. For example, information indicating the difference between the first wireless quality and the second wireless quality can be generated and communicated to the base station device 101. In one example, the difference is represented in 16 levels and can be reported as 4-bit information. Note that the number of levels and the number of bits are examples, and 8 levels may be represented by 3 bits, or 64 levels may be represented by 6 bits. The levels can be in 1 dB increments in one example, but may have any incremental width, such as 2 dB increments, 0.5 dB increments, or predetermined non-uniform increments.

Note that the base station device 101 may, for example, receive an SRS from the terminal device 102 during communication using the second beam, calculate a wireless quality assuming a case where the first beam is formed using that SRS, compare that wireless quality with the wireless quality measured by the terminal device 102 for the communication using the second beam, and then determine whether to switch the beam to be used to the first beam. For example, the base station device 101 can estimate the state of the transmission path, such as path loss, based on the SRS, and then estimate a first reception power pertaining to the signal at the terminal device 102 based on the gain obtained when the first beam is formed and the transmission power that can be used by the base station device 101. The base station device 101 may then receive a report from the terminal device 102 on a second reception power pertaining to the signal transmitted using the second beam, and determine to use the first beam if the first reception power exceeds the second reception power by more than a predetermined level. The reception power is an example of the wireless quality, but another indicator may be used instead. The base station device 101 may also determine to use the first beam if the first reception power exceeds the second reception power by more than a predetermined level throughout a predetermined period. In this manner, switching from the second beam to the first beam may be performed in a manner similar to the approach described above.

According to the foregoing processing, it is possible to appropriately switch between the first beam based on the SRS, and the second beam based on the PMI, based on the state of the transmission path at the terminal device 102. For example, the second beam, which has a relatively high stability, can be used when it is assumed that the gain obtained by the first beam will decrease in response to changes in the state of the transmission path due to the terminal device 102 moving or the like, and that sufficient throughput will not be achieved. As a result, the throughput of the system as a whole can be improved while increasing the stability of the communication by using the first beam, which has a higher gain, when the state of the transmission path is stable, such as when the terminal device 102 is at rest.

Device Configuration

An example of the hardware configuration of the base station device 101 described above will be given next with reference to FIG. 2. In one example, the base station device 101 includes a processor 201, a ROM 202, a RAM 203, a storage device 204, and a communication circuit 205. The processor 201 is a computer configured including at least one processing circuit such as a general-purpose central processing unit (CPU), an application specific integrated circuit (ASIC), or the like, and executes overall processing of the base station device 101, the individual processes described above, and the like by reading out programs stored in the ROM 202, the storage device 204, and the like and executing the programs. The ROM 202 is a read-only memory that stores programs, information such as various parameters, and the like pertaining to the processing executed by the base station device 101. The RAM 203 functions as a workspace when the processor 201 executes programs, and is a random access memory that stores temporary information. The storage device 204 is constituted by, for example, a removable external storage device or the like. The communication circuit 205 is constituted by a circuit for LTE or 5G wireless communication, for example. Although one communication circuit 205 is illustrated in FIG. 2, the base station device 101 can have a plurality of communication circuits, e.g., wireless communication circuits for LTE and 5G and wired communication circuits for wired communication. The base station device 101 may have separate communication circuits 205 for each of a plurality of frequency bands that can be used, or may have a common communication circuit 205 for at least some of those frequency bands.

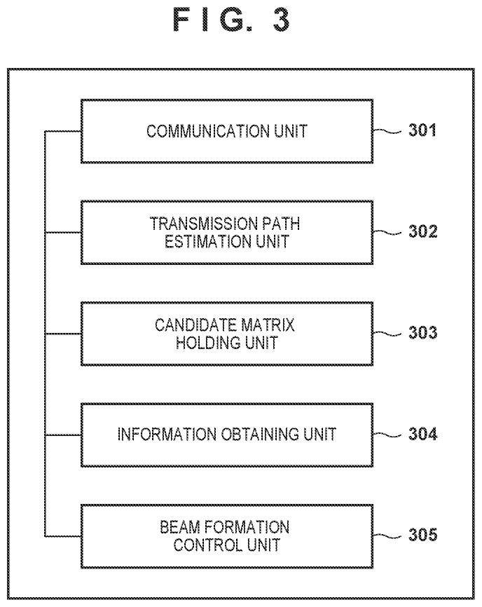

FIG. 3 illustrates an example of the functional configuration of the base station device 101 according to the present embodiment. The base station device 101 includes, for example, a communication unit 301, a transmission path estimation unit 302, a candidate matrix holding unit 303, an information obtaining unit 304, and a beam formation control unit 305, as an example of the functional configuration. Note that FIG. 3 illustrates only the parts of the functions of the base station device 101 that are relevant to the descriptions of the present embodiment, and the base station device 101 of course has the functions of a base station device 101 of a general cellular communication system. The base station device 101 may have functions other than the functions illustrated in FIG. 3 and generic functions as the base station device 101. The function blocks in FIG. 3 are illustrated schematically, and the function blocks may be realized as an integrated unit, or may be further subdivided. Each of the functions in FIG. 3 may be realized, for example, by the processor 201 executing a program stored in the ROM 202 or the storage device 204, or by a processor inside the communication circuit 205 executing predetermined software.

The communication unit 301 forms a beam based on the state of the transmission path with the terminal device and performs wireless communication with the terminal device. The communication unit 301 is configured, for example, to form a beam at a high gain in a predetermined direction by multiplying a modulated signal to be transmitted to the terminal device by a predetermined weight for each transmitting antenna and transmitting the obtained signals in parallel. The communication unit 301 can transmit a plurality of signal streams in parallel by multiplying each of the plurality of signal streams by a separate antenna weight and transmitting the resulting signals in separate directions. In this case, each antenna sends out a waveform that is the sum of the components of the plurality of signal streams.

The transmission path estimation unit 302 performs transmission path estimation based on an uplink wireless signal received from the terminal device. The transmission path estimation unit 302, for example, performs the transmission path estimation based on the SRS received from the terminal device, and holds the result as an estimated value of the downlink transmission path. The SRS is an example of the uplink wireless signal, and transmission path estimation may be performed using other wireless signals. The candidate matrix holding unit 303 holds a plurality of candidates for a precoding matrix, defined in advance. Each of the plurality of candidates is given an indicator, and the precoding matrix that should be used is specified by the PMI from the terminal device.

The communication unit 301 can generate a precoding matrix based on the state of the transmission path estimated by the transmission path estimation unit 302, form the first beam using that matrix, and communicate with the terminal device. The communication unit 301 can also select a precoding matrix, among the precoding matrix candidates held by the candidate matrix holding unit 303, which has been specified by the PMI from the terminal device, form the second beam using that matrix, and communicate with the terminal device.

The information obtaining unit 304 obtains information for determining whether to use the first beam or the second beam. For example, during communication using the first beam, the information obtaining unit 304 obtains information which can specify the first wireless quality at the terminal device for the first wireless signal transmitted using the first beam, from the terminal device through the communication unit 301. The information obtaining unit 304 also obtains the second wireless quality at the terminal device for the second wireless signal transmitted using a predetermined beam related to the second beam (e.g., that is used to determine the second beam). The first wireless quality and the second wireless quality can be, for example, a signal-to-interference and noise ratio (SINR). The first wireless signal can be, for example, a DMRS transmitted immediately before user data addressed to the terminal device. The first wireless signal may be, for example, a CSI-RS unique to the terminal device, transmitted using the first beam. In addition, yet another signal may be used as the first wireless signal. The second wireless signal can be, for example, a cell-specific (common to terminal devices in a cell) CSI-RS. Note that the CSI-RS is mapped to a resource based on the number of CSI-RS ports and transmitted in a predetermined period, in the predetermined beam for the selection of the second beam, for example. Note also that the predetermined beam is a beam having a wider beam width than the beam unique to the terminal device formed based on the SRS or the like, and may be an omnidirectional beam.

In one example, the information obtaining unit 304 may obtain one piece of information generated based on the first wireless quality and the second wireless quality. This one piece of information can be, for example, a difference value between the first wireless quality and the second wireless quality. A value obtained by subtracting the second wireless quality from the first wireless quality can be communicated from the terminal device to the base station device 101 as 4-bit information in 16 levels, e.g., less than 0 dB, at least 0 dB and less than 1 dB, at least 1 dB and less than 2 dB, . . . , at least 13 dB and less than 14 dB, and at least 14 dB. Note, however, that this is only one example, and the difference value may be expressed in a step width of, for example, 2 dB increments or the like. 32 levels of information may be communicated using 5 bits, or only 8 levels of information may be communicated using 3 bits. Only the difference value may be communicated, or either the first wireless quality or the second wireless quality may be communicated together with the difference value. For example, the terminal device can notify the base station device 101 of the first wireless quality and the difference value. The base station device 101 may set the terminal device with respect to the information to be communicated. For example, setting information indicating whether to communicate only the difference value, communicate the difference value and the first wireless quality or the second wireless quality, or communicate the first wireless quality and the second wireless quality can be communicated to the terminal device using an RRC message when establishing a connection.

The information obtaining unit 304 may, for example, receive a signal transmitted from the terminal device and calculate the estimated value of the wireless quality corresponding to the first wireless quality, the second wireless quality, or the like described above based on that signal. For example, the information obtaining unit 304 measures an amplitude variation, an amount of phase rotation, or the like when signals transmitted from each antenna of the terminal device arrive at each antenna of the base station device 101. The information obtaining unit 304 multiplies the signal to be sent out from each antenna, corresponding to the antenna weights corresponding to the first beam and the predetermined beam, by the amplitude variation and the amount of phase rotation measured at each antenna based on the signal sent out from one antenna of the terminal device. How the signal will be received at the one antenna of the terminal device can be estimated by adding up all the results of the multiplication. Doing so makes it possible for the information obtaining unit 304 to estimate the first wireless quality and the second wireless quality within that device without receiving reports from the terminal device.

The beam formation control unit 305 determines whether to use the first beam or the second beam based on the first wireless quality and the second wireless quality, or the difference value between those qualities, obtained by the information obtaining unit 304. The beam formation control unit 305 then controls the communication unit 301 to form a beam based on that determination. The beam formation control unit 305 performs control to use the first beam during an initial connection, for example. The beam formation control unit 305 then switches the beam to be used for communication from the first beam to the second beam based on, for example, the fact that the difference between the levels of the first wireless quality and the second wireless quality has fallen below a predetermined level. As an example, the beam formation control unit 305 can switch the beam to be used for communication from the first beam to the second beam based on the level of the first wireless quality falling below the level of the second wireless quality.

Flow of Processing

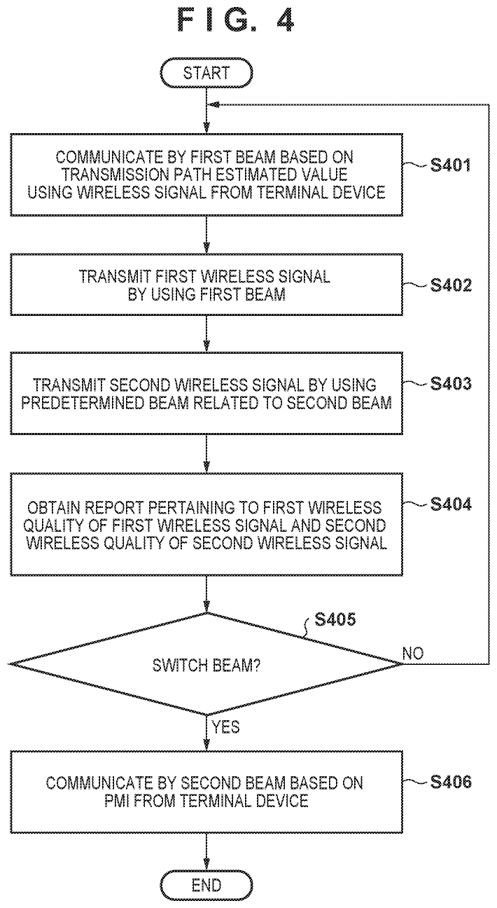

An example of the flow of processing executed by the base station device 101 according to the present embodiment will be described next with reference to FIG. 4. This processing can be realized, for example, by the processor 201 executing a program stored in the ROM 202, the storage device 204, or the like. The criteria for switching the beam to be used by the base station device 101 are as described above, and thus an example of the flow of processing executed by the base station device 101 will be outlined here, without repeating the details thereof.

The base station device 101 first establishes a connection with the terminal device and starts communication using the first beam (S401). For example, the base station device 101 causes the terminal device with which the connection has been established to transmit an SRS, forms the first beam based on the result of measuring that SRS, and transmits user data to the terminal device. Then, for example, the base station device 101 uses the first beam to transmit the first wireless signal, such as a DMRS or a CSI-RS, immediately before transmitting the user data (S402), and causes the terminal device to measure the first wireless quality pertaining to the first wireless signal. Even during communication using the first beam, the base station device 101 sends the second wireless signal through periodic transmission of the CSI-RS or the like, using the predetermined beam related to the second beam based on the PMI (S403). Note that the base station device 101 periodically sends the CSI-RS using the predetermined beam even when not connected to a terminal device. The base station device 101 transmits the DMRS before transmitting the user data to the terminal device, as described above. In this manner, the order of S401 to S403 is only one example, and these steps may be executed in a different order.

The base station device 101 then receives a report from the terminal device regarding the first wireless quality pertaining to the first wireless signal and the second wireless quality pertaining to the second wireless signal (S404). This report may be, for example, a report that includes information indicating the first wireless quality and the second wireless quality, or a report that includes information indicating the level difference between the first wireless quality and the second wireless quality (and information indicating the first wireless quality or the second wireless quality, as appropriate). Note that if the base station device 101 can estimate the first wireless quality and the second wireless quality using the uplink signal transmitted from the terminal device or the like, the processing of S402 to S403 may be replaced with the measurement of the uplink wireless signal and calculation of the wireless quality.

The base station device 101 then determines whether to switch the beam to be used from the first beam to the second beam based on the relationship between the first wireless quality and the second wireless quality (S405). If the base station device 101 determines not to switch from the first beam to the second beam (NO in S405), the processing returns to S401, where whether the first wireless quality has degraded to the extent or approaching the second wireless quality continues to be monitored. On the other hand, if the base station device 101 determines to switch from the first beam to the second beam (YES in S405), the beam to be used is switched to the second beam, and a signal (user data) is transmitted to the terminal device (S406). The base station device 101 periodically transmits the CSI-RS, and the terminal device that observes the CSI-RS estimates the state of the downlink transmission path and notifies the base station device 101 of the PMI identified based on the estimation result. The base station device 101 communicates with the second beam using precoding matrix designated by the PMI received from the terminal device.

Then, after the switch to the second beam, the base station device 101 may then switch to the first beam in response to the terminal device determining that the state of the transmission path is stable. If the base station device 101 has switched to the first beam, the processing of FIG. 4 can be executed again.

Through the above-described processing, the base station device 101 can appropriately switch between using the first beam, which is based on a precoding matrix generated from an estimated value of the state of the transmission path based on wireless signals from the terminal device, and using the second beam, which is based on a precoding matrix based on a result of the terminal device selecting from among a plurality of candidates, according to the state of the terminal device. As a result, using the second beam when there is a large change in the state of the transmission path, such as when the terminal device is moving, and using the first beam when there is a small change in the state of the transmission path, stable and high-quality communication suited to the situation can be performed.

### Second Embodiment

The present embodiment will describe a case where the terminal device 102 forms a beam and transmits a signal to the base station device 101. Such communication is performed, for example, by the base station device 101 estimating the state of the transmission path based on an uplink signal (e.g., an SRS (Sounding Reference Signal) transmitted from the terminal device 102, selecting, based on the estimated value, a codebook to be used by the terminal device 102 from among a plurality of codebooks in which a beamforming pattern has been parameterized, and notifying the terminal device 102 of the selected codebook. The terminal device 102 can form a beam and transmit the uplink signal using the codebook for which the notification is made. In this processing, the base station device 101 executes the transmission path estimation, selects a codebook roughly suited to the state of the terminal device 102 from among codebooks determined in advance based on the result of the transmission path estimation, and makes a notification of only the result of the selection. As a result, the base station device 101 can notify the terminal device 102 of the beam to be used with a small amount of information.

On the other hand, in this case, the types of the codebooks are limited from the standpoint of reducing the amount of data communicated to the terminal device 102, and thus the codebook selected is only roughly suited to the state of the terminal device 102, which means a fine beam cannot be formed. Meanwhile, in the Fifth Generation (5G) New Radio (NR) standard, the usable frequency bandwidth has been expanded from previous standards, and thus transmitting a signal such as an SRS or the like across the entire frequency band can reduce the power that can be used in each set frequency range. As a result, the range within which the SRS transmitted by the terminal device 102 can be measured is narrow, and thus it is difficult for the terminal device 102, which is located at a distance from the base station device 101, to accurately estimate the transmission path using the SRS.

In the present embodiment, in light of such a situation, the base station device 101 transmits a predetermined signal such as an SRS throughout the entire usable frequency band in order to enable the terminal device 102 to form a highly accurate beam. Note that the SRS is only one example, and because the base station device 101 has a constant power density when transmitting a signal in each set frequency range, the predetermined signal can be transmitted with sufficient power throughout the entire usable frequency band. This makes it possible for the terminal device 102 to receive this predetermined signal with sufficient power even when located a significant distance from the base station device 101. The terminal device 102 receives this predetermined signal at each of the plurality of antennas, and estimates the state of the transmission path based on the predetermined signal. Then, based on the estimated state of the transmission path, the terminal device 102 calculates the antenna weight matrix and transmits a signal using the calculated antenna weight matrix. Through this, an antenna weight matrix that is better suited to the state of the transmission path can be used than when the base station device 101 determines the antenna weight matrix, which makes it possible to improve communication throughput.

Note that the base station device 101 may transmit information indicating whether to transmit the predetermined signal, such as an SRS, for enabling the terminal device 102 to estimate the transmission path (indicating whether to transmit the predetermined signal). In one example, the base station device 101 can individually transmit, to the terminal device 102, setting information indicating that the predetermined signal is to be transmitted, using an RRC (radio resource control) message. At this time, radio resources for transmitting the predetermined signal (frequency and time resources, such as a transmission timing in each frequency band) may be communicated. The base station device 101 may also make a notification of the presence or absence of the predetermined signal, the radio resources at the time of transmission, or the like based on a signal aside from an RRC message. The base station device 101 may also broadcast the presence or absence of the predetermined signal, such as an SRS, based on system information (SI), for example. When a predetermined signal, such as an SRS, is not transmitted, the terminal device 102 need not execute the processing for receiving the predetermined signal, and need not estimate the transmission path for beam formation.

Furthermore, when the base station device 101 does not transmit the predetermined signal, the base station device 101 may estimate the transmission path between the terminal device 102 and the base station device 101 based on a signal, such as the SRS, transmitted by the terminal device 102, and may select the codebook to be used by the terminal device 102 and notify the terminal device 102 based on the estimated value of the transmission path. Through this, the base station device 101 can switch the beam to be used by the terminal device 102 between a codebook-based beam and an SRS-based beam according to the circumstances.

As described above, according to the present embodiment, the base station device 101 can transmit a predetermined signal that enables the terminal device 102 to estimate the transmission path, such as an SRS, which makes it possible to form a high-precision beam in the terminal device 102 and perform high-throughput communication. Although the processing according to the present embodiment is particularly useful in a time-division duplex (TDD) system, the processing can also be applied in a frequency-division duplex (FDD) system.

Device Configuration

An example of the configuration of the base station device 101 and the terminal device 102 described above will be given next with reference to FIG. 2. Note that the hardware configurations of the base station device 101 and the terminal device 102 are the same as those illustrated in FIG. 2, for example, and will not be repeated here.

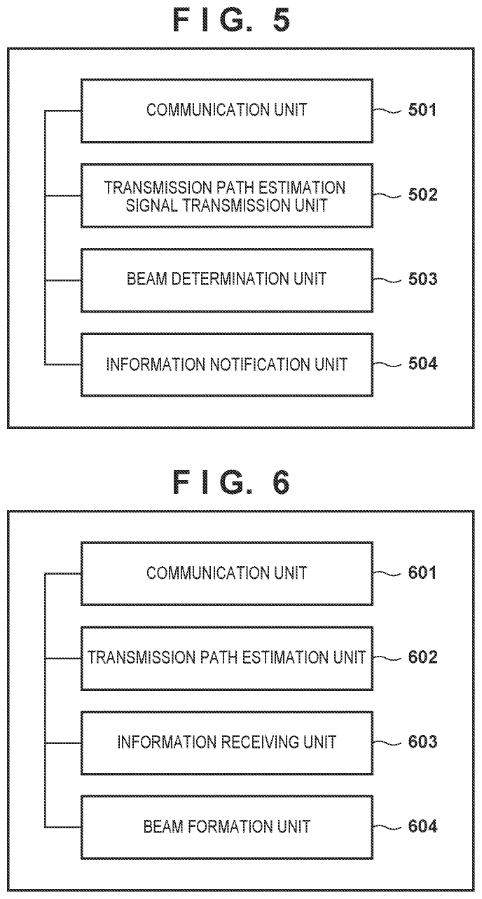

FIG. 5 illustrates an example of the functional configuration of the base station device 101 according to the present embodiment. The base station device 101 includes, for example, a communication unit 501, a transmission path estimation signal transmission unit 502, a beam determination unit 503, and an information notification unit 504, as an example of the functional configuration. Note that FIG. 5 illustrates only the parts of the functions of the base station device 101 that are relevant to the descriptions of the present embodiment, and the base station device 101 of course has the functions of a base station device 101 of a general cellular communication system. The base station device 101 may have functions other than the functions illustrated in FIG. 5 and generic functions as the base station device 101. The function blocks in FIG. 5 are illustrated schematically, and the function blocks may be realized as an integrated unit, or may be further subdivided. Each of the functions in FIG. 5 may be realized, for example, by the processor 201 executing a program stored in the ROM 202 or the storage device 204, or by a processor inside the communication circuit 205 executing predetermined software.

The communication unit 501 communicates wirelessly with the terminal device 102. Note that when the base station device 101 includes a plurality of antennas, the communication unit 501 may form a beam using the plurality of antennas to transmit and receive signals. The transmission path estimation signal transmission unit 502 executes processing for transmitting a predetermined signal the terminal device 102 to estimate the transmission path (e.g., an SRS) through the communication unit 501. Here, the predetermined signal is transmitted throughout the usable frequency band, for example, unlike the Channel State Information-Reference Signal (CSI-RS), which is transmitted only in a partial frequency range. For example, when the transmission path estimation signal transmission unit 502 does not transmit the predetermined signal, such as an SRS, the beam determination unit 503 executes the transmission path estimation based on the uplink signal (such as an SRS) transmitted by the terminal device 102, and selects the codebook to be used by the terminal device 102 from among a plurality of codebook candidates defined in advance. The information notification unit 504 notifies the terminal device 102 of various types of information through the communication unit 501. For example, when the transmission path estimation signal transmission unit 502 transmits the predetermined signal, such as an SRS, the information notification unit 504 can notify the terminal device 102, through the communication unit 501, of information indicating that the predetermined signal will be transmitted. Note that the information indicating that the predetermined signal will be transmitted can be expressed as 1-bit information. In one example, that the predetermined signal will be transmitted may be indicated by setting a bit assumed to be a reserved bit to 1 in an existing signal, such as system information, a higher-layer message, or the like. Additionally, a bit indicating whether to send the predetermined signal may be added to an existing message, or a new message may be defined separately. Meanwhile, when the transmission path estimation signal transmission unit 502 does not transmit the predetermined signal, such as an SRS, the information notification unit 504 communicates the information indicating the codebook to be used by the terminal device 102, determined by the beam determination unit 503, to the terminal device 102 through the communication unit 501.

FIG. 6 illustrates an example of the functional configuration of the terminal device 102 according to the present embodiment. The terminal device 102 includes, for example, a communication unit 601, a transmission path estimation unit 602, an information receiving unit 603, and a beam formation unit 604, as an example of the functional configuration. Note that FIG. 6 illustrates only the parts of the functions of the terminal device 102 that are relevant to the descriptions of the present embodiment, and the terminal device 102 of course has the functions of a terminal device 102 of a general cellular communication system. The terminal device 102 may have functions other than the functions illustrated in FIG. 6 and generic functions as terminal device 102. The function blocks in FIG. 6 are illustrated schematically, and the function blocks may be realized as an integrated unit, or may be further subdivided. Each of the functions in FIG. 6 may be realized, for example, by the processor 201 executing a program stored in the ROM 202 or the storage device 204, or by a processor inside the communication circuit 205 executing predetermined software.

The communication unit 601 communicates wirelessly with the base station device 101. Note that in the present embodiment, the terminal device 102 includes a plurality of antennas, and the communication unit 601 forms a beam using the plurality of antennas to transmit and receive signals. The transmission path estimation unit 602 receives the predetermined signal, such as an SRS, transmitted from the base station device 101 throughout the frequency band, and estimates the state of the transmission path between each of the at least one antenna of the base station device 101 and each of the plurality of antennas of the terminal device 102. The information receiving unit 603 receives information indicating whether the predetermined signal, such as an SRS, is to be transmitted by the base station device 101, for example. The transmission path estimation unit 602 executes the transmission path estimation based on the predetermined signal when the information receiving unit 603 has received the information indicating that the predetermined signal is to be transmitted. Based on the estimated value of the transmission path, the beam formation unit 604 calculates an antenna weight matrix corresponding to each of the plurality of antennas, forms a beam using the calculated antenna weight matrix, and transmits a signal including user data to the base station device 101.

Additionally, when the predetermined signal, such as an SRS, will not be transmitted by the base station device 101, the information receiving unit 603 can obtain information pertaining to the codebook to be used in the terminal device 102, determined by the base station device 101 based on the uplink signal such as an SRS transmitted by the communication unit 601. The beam formation unit 604 then specifies an antenna weight matrix to be used based on the codebook for which the notification was made, forms the beam using the specified antenna weight matrix, and transmits a signal including user data to the base station device 101. Note that when the information receiving unit 603 has received information indicating that the predetermined signal, such as an SRS, will not be transmitted by the base station device 101, the transmission path estimation unit 602 may refrain from estimating the transmission path for forming a beam.

Flow of Processing

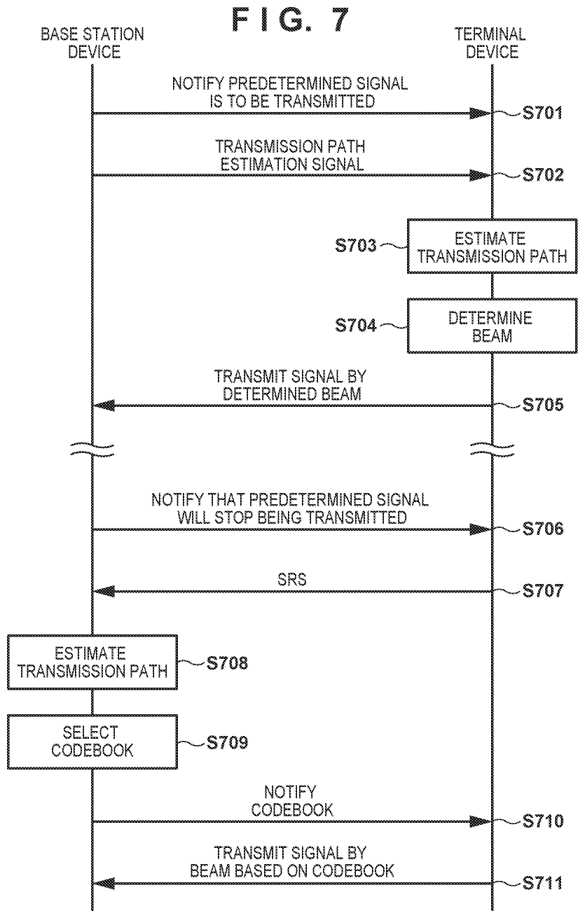

An example of the flow of processing executed in the wireless communication system according to the present embodiment will be described next with reference to FIG. 7. First, the base station device 101 notifies the terminal device 102 that the predetermined signal for estimating a transmission path, such as an SRS, is to be transmitted (S701). Note that this notification may be communicated to the terminal device 102 individually, or may be communicated to a plurality of terminal devices 102 simultaneously through broadcast, a multicast, or the like. In one example, the frequency/time resources with which the predetermined signal for transmission path estimation is transmitted are communicated through the notification made here. Although the predetermined signal is transmitted throughout the usable frequency band, the predetermined signal may be transmitted at different times in each frequency range, or may be transmitted simultaneously throughout the entire frequency band. Here, when the predetermined signal is transmitted simultaneously throughout the entire frequency band, it is possible to communicate only the timing of the transmission. Additionally, when the predetermined signal is transmitted at different timings from frequency range to frequency range, the transmission timings can be indicated individually for each frequency region divided into a plurality of regions. For example, a reference transmission timing for a frequency range serving as a reference may be indicated, and for the other frequency ranges, the transmission timing may be indicated by a difference from the reference transmission timing (an offset value). The base station device 101 then transmits the predetermined signal for estimating the transmission path (S702). Note that the base station device 101 may indicate that the predetermined signal is to be transmitted by indicating that the transmitted signal includes the predetermined signal, and in this case, the notification in S701 and the transmission of the predetermined signal in S702 may be performed simultaneously (in the same subframe). Furthermore, when the base station device 101 is to transmit the predetermined signal continually or the like, the notification in S701 may be omitted.

When the predetermined signal is transmitted by the base station device 101, the terminal device 102 measures the predetermined signal and estimates the state of the transmission path between each of the at least one antenna included in the base station device 101 and each of the plurality of antennas included in the terminal device 102 (S703). Then, based on the result of estimating the transmission path, the terminal device 102 determines a beam (antenna weight matrix) to be used when transmitting a signal such as user data to the base station device 101 (S704). The beam is assumed to be determined in accordance with various conventional techniques for determining antenna weight matrices, which will not be described in detail here. The terminal device 102 then forms a beam using the determined antenna weight matrix, and transmits a signal including user data or the like to the base station device 101 (S705). Note that the transmission of a predetermined signal for the transmission path estimation by the base station device 101, the transmission path estimation by the terminal device 102, and the calculation of the antenna weight matrix can be repeated periodically. As a result, an antenna weight matrix suited to the state of the terminal device 102 can be maintained, which makes it possible to improve throughput when the terminal device 102 transmits signals to the base station device 101.

Note that to simplify the descriptions, FIG. 7 illustrates only some of the overall processing related to the present embodiment, and some of the processing executed can be omitted. For example, the terminal device 102 can transmit the predetermined signal, such as an SRS, throughout the entire frequency band to enable the base station device 101 to determine which frequency resources should be used. The SRS can be transmitted in response to an instruction from the base station device 101. The base station device 101 can then specify a frequency range in which the path loss is low and the state is good, and allocate frequency resources to the terminal device 102 such that the signal is transmitted within that frequency range.

For example, when the terminal device 102 has begun to move at a high speed, the beam width of the beam calculated based on the predetermined signal may be narrow, and thus the throughput may drop sharply based on the beam direction and the positional relationship between and the terminal device 102 and the base station device 101. In such a case, the base station device 101 may stop transmitting the predetermined signal and select an antenna weight matrix to be used by the terminal device 102 from a codebook prepared in advance based on the signal transmitted from the terminal device 102. In addition, the base station device 101 may stop transmitting the predetermined signal when the transmission of user data should be prioritized without using resources for transmitting the predetermined signal for transmission path estimation, due to an increase in the number of terminal devices 102 being connected or the like, for example. In this case, the base station device 101 may notify the terminal device 102 that the predetermined signal will not be transmitted. In one example, the base station device 101 may explicitly notify the terminal device 102 that the predetermined signal will stop being transmitted (S706). In addition, the base station device 101 may implicitly notify the terminal device 102 that the predetermined signal will stop being transmitted by not transmitting a signal indicating that the predetermined signal will be transmitted. Then, by instructing the terminal device 102 to transmit the SRS, for example, the base station device 101 receives the SRS from the terminal device 102 (S707) and estimates the state of the transmission path based on the SRS (S708). The base station device 101 selects one codebook, among the plurality of codebooks prepared in advance, which is most suited to the estimated transmission path state (S709), and notifies the terminal device 102 of the selected codebook (S710).

The terminal device 102 also has information, in advance, pertaining to the plurality of codebooks, and the terminal device 102 can recognize the beam (antenna weight matrix) to be used by, for example, the base station device 101 communicating an index of the codebook to the terminal device 102. The terminal device 102 then forms a beam using the antenna weight matrix corresponding to the codebook for which the notification was made, and transmits a signal including user data or the like to the base station device 101 (S711).

In this manner, the base station device 101 can dynamically execute and stop the transmission of the predetermined signal, such as an SRS, for the transmission path estimation by the terminal device 102 according to the situation. Through this, the base station device 101 can stop the transmission of the predetermined signal by causing the terminal device 102 to use an antenna weight based on a codebook according to the situation while performing high-throughput communication using an antenna weight for estimating the transmission path with a high level of accuracy, which makes it possible to use those radio resources for other communication.

### Third Embodiment

The present embodiment will describe a case where the base station device 101 forms a beam and transmits a signal to the terminal device 102. For example, the terminal device 102 can observe a CSI-RS (Channel State Information Reference Signal) transmitted from the base station device 101 and estimate the state of the downlink transmission path based on that CSI-RS. Based on a result of the estimation, the terminal device 102 specifies one of a plurality of PMI (Precoding Matrix Indicator) values corresponding to respective ones of a plurality of antenna weight patterns prepared in advance, and notifies the base station device 101 of the specified PMI value. The base station device 101 can form a beam using the antenna weights corresponding to the PMI for which the notification was made, and communicate with the terminal device 102. The technique using the PMI makes it possible to set the beam with less feedback by having the terminal device 102 estimate the transmission path, select a roughly suitable beam based on the estimated value for that transmission path, and feed back only the result of that selection.

The CSI-RS is transmitted only in a specific frequency range that is a part of the usable frequency band. Accordingly, the state of the transmission path measured by the terminal device 102 is also related to that specific frequency range, and may not be suitable for other frequency ranges in the usable frequency band. In such a case, the beam corresponding to the PMI communicated from the terminal device 102 may no longer be appropriate for the frequency resources when the signal is transmitted from the base station device 101 to the terminal device 102.

In the present embodiment, in light of such a situation, the base station device 101 transmits a predetermined signal such as an SRS (Sounding Reference Signal) throughout the entire usable frequency band. Note that the SRS is merely an example, and another signal with which the transmission path can be estimated may be used. Here, because the base station device 101 has a constant power density when transmitting a signal in each set frequency range, the predetermined signal can be transmitted with sufficient power throughout the entire usable frequency band. This makes it possible for the terminal device 102 to receive this predetermined signal with sufficient power even when located a significant distance from the base station device 101.

The terminal device 102 receives this predetermined signal at each of the at least one antenna, and estimates the state of the transmission path for each of a plurality of frequency ranges based on that predetermined signal. Note that the plurality of frequency ranges are each part of a frequency band that can be used in the wireless communication system. Note that the plurality of frequency ranges may be configured not to overlap with each other, for example, by dividing the usable frequency band, or at least two frequency ranges may be configured to include frequency ranges that partially overlap with each other. However, the plurality of frequency ranges are set such that any one of the plurality of frequency ranges does not encompass other frequency ranges or become encompassed by other frequency ranges. Additionally, each frequency range may be set such that the entire usable frequency band is covered by the plurality of frequency ranges, or each frequency range may be set such that some (e.g., a small range of) frequency ranges are not included in the plurality of frequency ranges. The terminal device 102 selects a precoding matrix to be used by the base station device 101 from among precoding matrix candidates that can be used by the base station device 101 based on an estimated state of the transmission path for each of the plurality of frequency ranges. Then, for each of the plurality of frequency ranges, the terminal device 102 notifies the base station device 101 of the PMI corresponding to the selected precoding matrix. During this notification, for example, a message that directly describes the value of the PMI in each frequency range may be transmitted, or a message that includes the value of a PMI serving as a reference and difference values of the PMIs among each frequency range may be transmitted. In one example, the value of the reference PMI can be a value of a PMI suitable for the entire usable frequency band, and the difference values of the PMIs among the frequency ranges can be information indicating whether the value of the PMI is the same as or different from the value of the PMI. Meanwhile, the value of the PMI serving as the reference may be the value of the PMI in any of the frequency ranges. Through this, the base station device 101 can, for example, specify a frequency range in which a PMI that is the same as the reference PMI can be used, and allocate resources such that signals are transmitted to the terminal device 102 in that frequency range.

Note that the base station device 101 may transmit information indicating whether to transmit the predetermined signal, such as an SRS, for enabling the terminal device 102 to estimate the transmission path (indicating whether to transmit the predetermined signal). In one example, the base station device 101 can individually transmit, to the terminal device 102, setting information indicating that the predetermined signal is to be transmitted, using an RRC (radio resource control) message. At this time, radio resources for transmitting the predetermined signal (frequency and time resources, such as a transmission timing in each frequency band) may be communicated. The base station device 101 may also make a notification of the presence or absence of the predetermined signal, the radio resources at the time of transmission, or the like based on a signal aside from an RRC message. The base station device 101 may also broadcast the presence or absence of the predetermined signal, such as an SRS, based on system information (SI), for example. The terminal device 102 may select a precoding matrix (PMI) to be used by the base station device 101 based on the CSI-RS when a predetermined signal such as an SRS is not to be transmitted. Note that the CSI-RS is merely an example, and in this case, the terminal device 102 may estimate the transmission path and select the precoding matrix based on another signal which is transmitted by the base station device 101 and which has a narrower frequency range than the predetermined signal.

As described above, according to the present embodiment, the beam to be used by the base station device 101 in each frequency range can be selected in the terminal device 102 by enabling the base station device 101 to transmit a predetermined signal that enables the terminal device 102 to estimate the transmission path, such as an SRS. This makes it possible to ensure that, in downlink communication, a beam suited to the frequency resources to be used is formed by the base station device 101.

Device Configuration

An example of the configuration of the base station device 101 and the terminal device 102 described above will be given next with reference to FIG. 2. Note that the hardware configurations of the base station device 101 and the terminal device 102 are the same as those illustrated in FIG. 2, for example, and will not be repeated here.

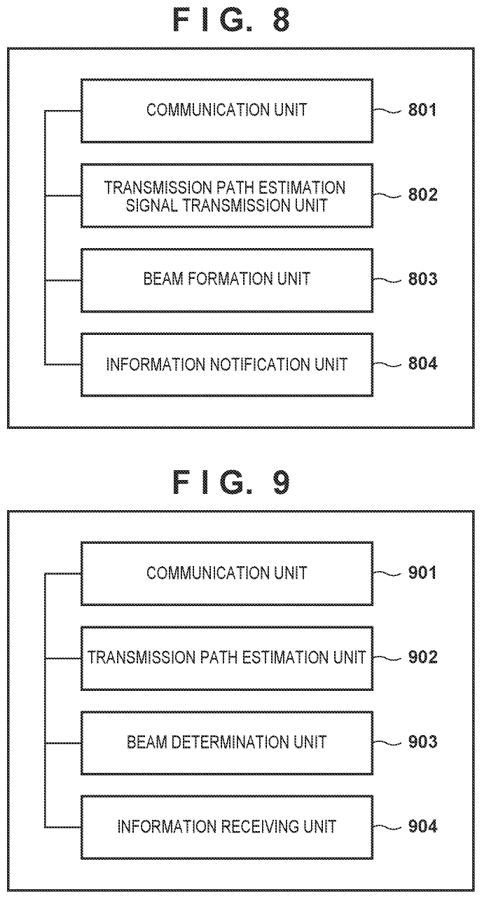

FIG. 8 illustrates an example of the functional configuration of the base station device 101 according to the present embodiment. The base station device 101 includes, for example, a communication unit 801, a transmission path estimation signal transmission unit 802, a beam setting unit 803, and an information notification unit 804, as an example of the functional configuration. Note that FIG. 8 illustrates only the parts of the functions of the base station device 101 that are relevant to the descriptions of the present embodiment, and the base station device 101 of course has the functions of a base station device 101 of a general cellular communication system. The base station device 101 may have functions other than the functions illustrated in FIG. 8 and generic functions as the base station device 101. The function blocks in FIG. 8 are illustrated schematically, and the function blocks may be realized as an integrated unit, or may be further subdivided. Each of the functions in FIG. 8 may be realized, for example, by the processor 201 executing a program stored in the ROM 202 or the storage device 204, or by a processor inside the communication circuit 205 executing predetermined software.

The communication unit 801 communicates wirelessly with the terminal device 102. Note that the communication unit 801 transmits a signal by forming a beam using the plurality of antennas. The transmission path estimation signal transmission unit 802 executes processing for transmitting a predetermined signal the terminal device 102 to estimate the transmission path (e.g., an SRS) through the communication unit 801. Here, the predetermined signal is transmitted throughout the usable frequency band, for example, unlike the Channel State Information-Reference Signal (CSI-RS), which is transmitted only in a partial frequency range. The terminal device 102 receives the predetermined signal and estimates the transmission path based on the predetermined signal received. Then, the terminal device 102 specifies, based on the estimated value of the transmission path, a precoding matrix, among a plurality of precoding matrix candidates, which is suitable for use by the base station device 101, for each of the plurality of frequency ranges. Note that the plurality of frequency ranges are each part of a frequency band that can be used in the wireless communication system. The base station device 101 is notified of the specified precoding matrix by a signal containing information pertaining to the result of the specifying.

The beam setting unit 803 obtains information pertaining to the precoding matrix for each of the plurality of frequency ranges from the terminal device 102 through the communication unit 801. The beam setting unit 803 then sets the antenna weights used by the communication unit 801 using the precoding matrix for the frequency range corresponding to the frequency resources to be used when the communication unit 801 transmits the signal to the terminal device 102. Through this, the communication unit 801 can transmit signals to the terminal device 102 using a beam suited to the allocated frequency resources. The information notification unit 804 notifies the terminal device 102 of various types of information through the communication unit 801. For example, when the transmission path estimation signal transmission unit 802 transmits the predetermined signal, such as an SRS, the information notification unit 804 can notify the terminal device 102, through the communication unit 801, of information indicating that the predetermined signal will be transmitted. Note that the information indicating that the predetermined signal will be transmitted can be expressed as 1-bit information. In one example, that the predetermined signal will be transmitted may be indicated by setting a bit assumed to be a reserved bit to 1 in an existing signal, such as system information, a higher-layer message, or the like. Additionally, a bit indicating whether to send the predetermined signal may be added to an existing message, or a new message may be defined separately.

FIG. 9 illustrates an example of the functional configuration of the terminal device 102 according to the present embodiment. The terminal device 102 includes, for example, a communication unit 901, a transmission path estimation unit 902, a beam determination unit 903, and an information receiving unit 904, as an example of the functional configuration. Note that FIG. 9 illustrates only the parts of the functions of the terminal device 102 that are relevant to the descriptions of the present embodiment, and the terminal device 102 of course has the functions of a terminal device 102 of a general cellular communication system. The terminal device 102 may have functions other than the functions illustrated in FIG. 9 and generic functions as terminal device 102. The function blocks in FIG. 9 are illustrated schematically, and the function blocks may be realized as an integrated unit, or may be further subdivided. Each of the functions in FIG. 9 may be realized, for example, by the processor 201 executing a program stored in the ROM 202 or the storage device 204, or by a processor inside the communication circuit 205 executing predetermined software.

The communication unit 901 communicates wirelessly with the base station device 101. Note that when the terminal device 102 includes a plurality of antennas, the communication unit 901 may form a beam using the plurality of antennas to transmit and receive signals to and from the base station device 101. The transmission path estimation unit 902 receives the predetermined signal, such as an SRS, transmitted from the base station device 101 throughout the frequency band, and estimates the state of the transmission path between each of the at least one antenna of the base station device 101 and each of the plurality of antennas of the terminal device 102. For example, the transmission path estimation unit 902 obtains, for each of the plurality of frequency ranges, the estimated value of the state of the transmission path. Note that the plurality of frequency ranges are each part of a frequency band that can be used in the wireless communication system.

The beam determination unit 903 determines the precoding matrix to be used by the base station device 101 by selecting a precoding matrix from among the precoding matrix candidates prepared in advance, for each of the plurality of frequency ranges. Then, the beam determination unit 903 notifies the base station device 101 of information on the precoding matrix selected for each of the frequency ranges. For example, the PMI of each of the plurality of frequency ranges can be communicated to the base station device 101. For example, the PMI that is suited to the entire usable frequency band may be taken as a reference PMI, and the base station device 101 may be notified of the difference value between that PMI value and the PMI of each of the plurality of frequency ranges. At this time, a bitmap indicating the value of the reference PMI and whether the value of the PMI for each of the plurality of frequency ranges is the same as the value of the reference PMI may be communicated to the base station device 101. The PMI value having the highest frequency of occurrence among the PMIs for the plurality of frequency ranges may be used as the reference PMI value.

The information receiving unit 904 receives information indicating whether the predetermined signal, such as an SRS, is to be transmitted by the base station device 101, for example. The transmission path estimation unit 902 executes the transmission path estimation based on the predetermined signal when the information receiving unit 904 has received the information indicating that the predetermined signal is to be sent. Then, as described above, the beam determination unit 903 determines the precoding matrix for each of the plurality of frequency ranges, and notifies the base station device 101 of the results thereof. On the other hand, the transmission path estimation unit 902 can execute the transmission path estimation based on the CSI-RS, for example, when the information receiving unit 904 has received information indicating that the predetermined signal is not to be transmitted. Then, the beam determination unit 903 selects the precoding matrix based on the estimated value of the transmission path, and notifies the base station device 101 of the corresponding PMI. Note that the information communicated to the base station device 101 may include, for example, information indicating whether to communicate the PMIs pertaining to the plurality of frequency ranges determined based on the predetermined signal, or to communicate a single PMI determined based on the CSI-RS.

Flow of Processing

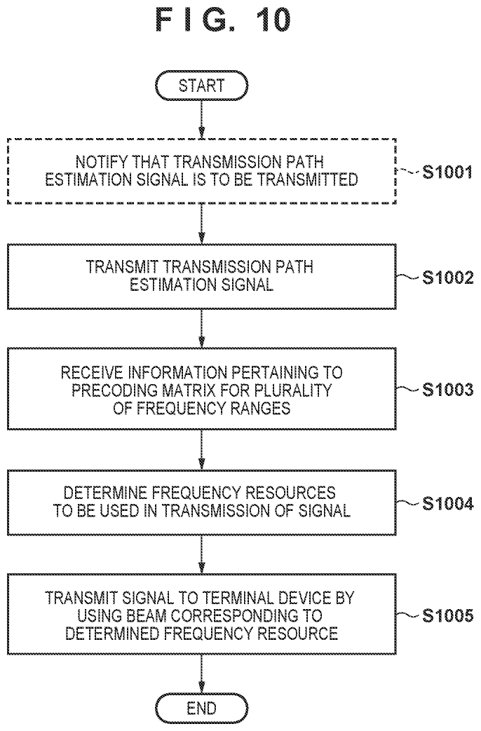

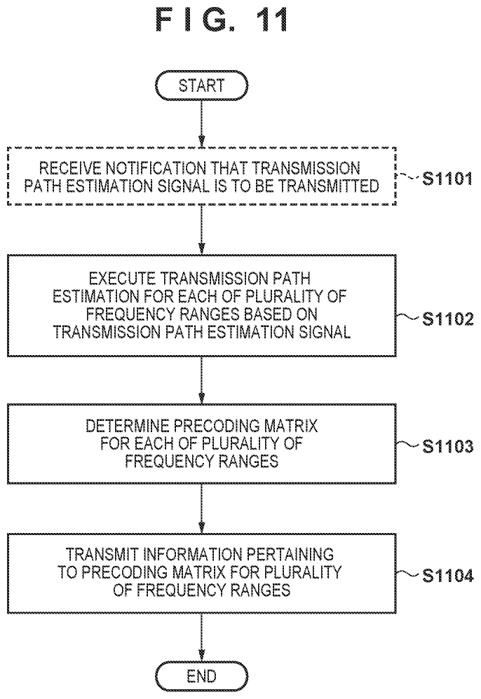

An example of the flow of processing executed by the base station device 101 and the terminal device 102 will be described next with reference to FIGS. 10 and 11. FIG. 10 illustrates an example of the flow of processing executed by the base station device 101, whereas FIG. 11 illustrates an example of the flow of processing executed by the terminal device 102. This processing is started, for example, by the processor 201 of the base station device 101 and the terminal device 102 launching a program stored in the ROM 202.

First, the base station device 101 notifies the terminal device 102 of information indicating that the predetermined signal for estimating a transmission path, such as an SRS, is to be transmitted (S1001), and the terminal device 102 receives that notification (S1101). Note that this notification may be communicated to the terminal device 102 individually, or may be communicated to a plurality of terminal devices 102 simultaneously through broadcast, a multicast, or the like. In one example, the frequency/time resources with which the predetermined signal for transmission path estimation is transmitted are communicated through the notification made here. Although the predetermined signal is transmitted throughout the usable frequency band, the predetermined signal may be transmitted at different times in each frequency range, or may be transmitted simultaneously throughout the entire frequency band. Here, when the predetermined signal is transmitted simultaneously throughout the entire frequency band, it is possible to communicate only the timing of the transmission. Additionally, when the predetermined signal is transmitted at different timings from frequency range to frequency range, the transmission timings can be indicated individually for each frequency region divided into a plurality of regions. For example, a reference transmission timing for a frequency range serving as a reference may be indicated, and for the other frequency ranges, the transmission timing may be indicated by a difference from the reference transmission timing (an offset value). Note that this notification need not necessarily be transmitted or received.

Then, the base station device 101 transmits the predetermined signal for transmission path estimation (S1002), and the terminal device 102 receives that signal for transmission path estimation and executes the transmission path estimation for each of the plurality of frequency ranges based on that signal (S1102). Here, the plurality of frequency ranges are each part of a frequency band that can be used in the wireless communication system. Note that the base station device 101 may indicate that a predetermined signal will be transmitted by indicating that the signal includes the predetermined signal within the predetermined signal, and in this case, the notification in S1001 and the transmission of the predetermined signal in S1002 can be performed simultaneously (in the same subframe). Furthermore, when the base station device 101 is to transmit the predetermined signal continually or the like, the notification and transmission/reception in S1001 and S1101 may be omitted.

The terminal device 102 selects and determines, from among precoding matrix candidates prepared in advance, a precoding matrix for each of the plurality of frequency ranges, based on the transmission path estimated values for the plurality of frequency ranges (S1103). The terminal device 102 then notifies the base station device 101 of information pertaining to the determined precoding matrix (S1104). Note that the terminal device 102 can transmit information indicating the PMI for each frequency range to the base station device 101, for example. At this time, the reference PMI and the difference value between the PMI in each frequency range and the reference PMI may be transmitted, or the value of the PMI itself in each frequency range may be transmitted without using the reference PMI. In addition, only information indicating whether the PMI for each frequency range is the same as the reference PMI may be communicated.

The base station device 101 receives the information pertaining to the precoding matrix from the terminal device 102 (S1003). Then, the base station device 101 determines the frequency resources to be used in the transmission of the signal to the terminal device 102 (S1004), specifies the PMI for the frequency range corresponding to the frequency resources, forms a beam using the precoding matrix corresponding to that PMI, and transmits the signal to the terminal device 102 (S1005). Note that the base station device 101 may, for example, select frequency resources for which the same antenna weights can be used. In other words, a frequency range having a common PMI may be specified, and the frequency resources to be used may be determined within that frequency range.

In this manner, the base station device 101 transmits the predetermined signal for the terminal device 102 to estimate the transmission path, such as an SRS, over the entire usable frequency band. Through this, the terminal device 102 can perform the transmission path estimation throughout the entire usable frequency band, and can select an appropriate precoding matrix for each frequency range corresponding to a part of a wide range of frequency bands. As a result, the base station device 101 can form a beam suitable for the frequency resources to be used in transmitting signals to the terminal device 102, and can transmit signals to the terminal device 102 with high efficiency.

According to the present disclosure, advancements in communication using beams can be achieved, and spatial resources can therefore be even more effectively utilized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A communication device comprising:
one or more processors; and
one or more memories that store a computer-readable instruction for causing, when executed by the one or more processors, the one or more processors to function as:
an estimation unit configured to estimate a state of a transmission path between the communication device and a partner device, using a wireless signal transmitted from the partner device;
an obtaining unit configured to obtain information pertaining to specification of a beam used when the communication device transmits a signal to the partner device, determined by the partner device based on the wireless signal transmitted by the communication device;
a communication unit configured to communicate with the partner device by forming a first beam used when transmitting a signal to the partner device based on the state of the transmission path estimated, or by forming a second beam used when transmitting a signal to the partner device based on the information obtained; and
a control unit configured to control, during communication with the partner device using the first beam, the communication unit to switch a beam to be used from the first beam to the second beam based on a first wireless quality in the partner device for a first wireless signal transmitted using the first beam and a second wireless quality in the partner device for a second wireless signal transmitted using a predetermined beam related to the second beam.

2. The communication device according to claim 1, wherein
the control unit performs control so as to switch from the first beam to the second beam based on a difference between the first wireless quality and the second wireless quality dropping below a predetermined level.

3. The communication device according to claim 1, wherein
the control unit performs control so as to switch from the first beam to the second beam based on the first wireless quality dropping below the second wireless quality.

4. The communication device according to claim 1, wherein
the control unit determines whether to switch the beam to be used from the first beam to the second beam based on a report pertaining to the first wireless quality and a report pertaining to the second wireless quality, the reports being received from the partner device by the communication unit.

5. The communication device according to claim 1, wherein
the control unit determines whether to switch the beam to be used from the first beam to the second beam based on a report generated based on the first wireless quality and the second wireless quality obtained from the partner device, the report being received from the partner device by the communication unit.

6. The communication device according to claim 1, wherein
the first wireless signal includes a demodulation reference signal or a channel state information reference signal.

7. The communication device according to claim 1, wherein
the second wireless signal includes a channel state information reference signal.

8. The communication device according to claim 1, wherein
the communication device is a base station device in a cellular communication system, and the partner device is a terminal device in the cellular communication system.

9. The communication device according to claim 8, wherein
the estimation unit estimates the state of the transmission path between the communication device and the partner device based on a sounding reference signal (SRS) received from the terminal device.

10. The communication device according to claim 8, wherein
the obtaining unit obtains a PMI (Precoding Matrix Indicator) as the information pertaining to the specification of the beam used when the communication device transmits a signal to the partner device.

11. A communication method executed by a communication device, wherein:
the communication device is configured to communicate with a partner device by forming a first beam used when transmitting a signal to the partner device based on a state of a transmission path between the communication device and the partner device estimated using a wireless signal transmitted from the partner device, or by forming a second beam used when transmitting a signal to the partner device based on information, determined by the partner device based on a wireless signal transmitted by the communication device, that pertains to specification of a beam used when the communication device transmits a signal to the partner device; and
the communication method comprises performing control, during communication with the partner device using the first beam, such that a beam to be used is switched from the first beam to the second beam based on a first wireless quality in the partner device for a first wireless signal transmitted using the first beam and a second wireless quality in the partner device for a second wireless signal transmitted using a predetermined beam related to the second beam.

12. A non-transitory computer-readable storage medium that stores a program for causing, when executed by a computer included in a communication device, the communication device to execute a communication method,
wherein the communication device is configured to communicate with a partner device by forming a first beam used when transmitting a signal to the partner device based on a state of a transmission path between the communication device and the partner device estimated using a wireless signal transmitted from the partner device, or by forming a second beam used when transmitting a signal to the partner device based on information, determined by the partner device based on a wireless signal transmitted by the communication device, that pertains to specification of a beam used when the communication device transmits a signal to the partner device; and
the communication method comprises performing control, during communication with the partner device using the first beam, such that a beam to be used is switched from the first beam to the second beam based on a first wireless quality in the partner device for a first wireless signal transmitted using the first beam and a second wireless quality in the partner device for a second wireless signal transmitted using a predetermined beam related to the second beam.
